(19) United States
(12) Patent Application Publication
(10) Pub. No.: US 2002/0174054 A1
(43) Pub. Date: Nov. 21, 2002

(54) Method and apparatus for non-price auctions

(75) Inventors: William Grey, Millwood, NY (US); Clifford A. Pickover, Yorktown Heights, NY (US); Paul Andrew Moskowitz, Yorktown Heights, NY (US); Stephen J. Boies, Mahopac, NY (US); Dailun Shi, Croton on Hudson, NY (US)

Correspondence Address: Duke W. Yee, Carstens, Yee & Cahoon, LLP, P.O. Box 802334, Dallas, TX, 75380, US

(73) Assignee: International Business Machines Corporation, Armonk, NY

(21) Appl. No.: 09/859,712

(22) Filed: May 17, 2001

(51) Int. Cl. G06F 17/60

(52) U.S. Cl. 705/37; 705/26

(57) ABSTRACT

A method, apparatus, and computer implemented instructions for auctioning in a data processing system. One or more parameters are provided for bidding on items, wherein the parameter exclude price. A set of bids is received for the items based on the one or more parameters. A winning bid is identified from the set of bids.

### BACKGROUND OF THE INVENTION

1. Technical Field

The present invention relates generally to an improved data processing system, and in particular to a method and apparatus for auctioning items over a network data processing system. Still more particularly, the present invention provides a method, apparatus, and computer implemented instructions for non-price auctions in a network data processing system.

2. Description of Related Art

The Internet, also referred to as an “internetwork”, is a set of computer networks, possibly dissimilar, joined together by means of gateways that handle data transfer and the conversion of messages from the sending network to the protocols used by the receiving network (with packets if necessary). When capitalized, the term “Internet” refers to the collection of networks and gateways that use the TCP/IP suite of protocols. The Internet has become a cultural fixture as a source of both information and entertainment. Many businesses are creating Internet sites as an integral part of their marketing efforts, informing consumers of the products or services offered by the business or providing other information seeking to engender brand loyalty. Many federal, state, and local government agencies are also employing Internet sites for informational purposes, particularly agencies, such as the Internal Revenue Service and secretaries of state, which must interact with virtually all segments of society. Providing informational guides and/or searchable databases of online public records may reduce operating costs. Further, the Internet is becoming increasingly popular as a medium for commercial transactions.

With respect to commerce on the Web, individual consumers and business use the Web to purchase various goods and services. In offering goods and services, some companies offer goods and services solely on the Web while others use the Web to extend their reach. For a long time, auctions have been a method of choice for buying a variety of goods and services. On the World Wide Web, a huge number of sites offer options whereby bidders can acquire a huge variety of products. For instance, celebrated portals such as “Yahoo.com”0 offer access to over a thousand sites such as eBay where the Web surfer can participate in auctions.

Typically, some goods, such as a car or an old watch, are offered for bid. For such items, the bidder gets the following type of information: item description, highest bid so far, and time of termination together with the possibility of looking at a picture of the item, and access to information about the item. Some tie breakers are usually offered in case several bids are communicated at the same time.

Typically, in auctions as they are practiced now, several policy variations exist.

For instance, several kinds of bidding rules are present, such as, for example, minimum starting bid, minimum increment, rules for withdrawing bids, quantity restriction, minimum, maximum, lot size, rules on reserve prices, hidden or revealed, conventions on anonymity or not during and after auction, and tie breaking rules. These auctions are always based on price in the sense that the bidding process attempts to determine an acceptable price for which two or more parties will conduct a transaction.

The present invention recognizes that instances may occur in which price is not a convenient attribute for auctioning items. For example, the present invention recognizes that a manufacturer that has fixed manufacturing costs may find it beneficial to sell its output at a fixed price, assuring a certain profit margin. This manufacturer may be more concerned with how many units of output are sold rather than price. The presently available auction systems are based on prices and do not permit this type of transaction.

Therefore, it would be advantageous to have an improved method and apparatus for auctioning items based on non-price attributes.

### SUMMARY OF THE INVENTION

The present invention provides for a method, apparatus, and computer implemented instructions for auctioning in a data processing system. One or more parameters are provided for bidding on items, wherein the parameters exclude price. A set of bids is received for the items based on the one or more parameters. A winning bid is identified from the set of bids.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a pictorial representation of a distributed data processing system in which the present invention may be implemented;

FIG. 2 is a block diagram of a data processing system that may be implemented as a server in accordance with a preferred embodiment of the present invention;

FIG. 3 is a block diagram illustrating a data processing system in which the present invention may be implemented;

FIG. 4 is a diagram illustrating components used in an Internet auction in accordance with a preferred embodiment of the present invention;

FIG. 5 is a flowchart of a process used for offering one or more items for auction in accordance with a preferred embodiment of the present invention; and

FIG. 6 is a flowchart of a process used for selecting a winner of an auction in accordance with a preferred embodiment of the present invention.

### DETAILED DESCRIPTION OF THE PREFERRED EMBODIMENT

With reference now to the figures, FIG. 1 depicts a pictorial representation of a distributed data processing system in which the present invention may be implemented. Distributed data processing system 100 is a network of computers in which the present invention may be implemented. Distributed data processing system 100 contains a network 102, which is the medium used to provide communications links between various devices and computers connected together within distributed data processing system 100. Network 102 may include permanent connections, such as wire or fiber optic cables, or temporary connections made through telephone connections. The communications network 102 also can include other public and/or private wide area networks, local area networks, wireless networks, data communication networks or connections, intranets, routers, satellite links, microwave links, cellular or telephone networks, radio links, fiber optic transmission lines, ISDN lines, T1 lines, DSL, etc. In some embodiments, a user device may be connected directly to a server 104 without departing from the scope of the present invention. Moreover, as used herein, communications include those enabled by wired or wireless technology.

In the depicted example, a server 104 is connected to network 102 along with storage unit 106. In addition, clients 108, 110, and 112 also are connected to network 102. These clients 108, 110, and 112 may be, for example, personal computers, portable computers, mobile or fixed user stations, workstations, network terminals or servers, cellular telephones, kiosks, dumb terminals, personal digital assistants, two-way pagers, smart phones, information appliances, or network computers. For purposes of this application, a network computer is any computer, coupled to a network, which receives a program or other application from another computer coupled to the network. In the depicted example, server 104 provides data, such as boot files, operating system images, and applications to clients 108-112. Clients 108, 110, and 112 are clients to server 104. In these particular examples, server 104 mayhost an on-line auction. Clients 108, 110, and 112 may receive information on items that are to be auctioned and submit bids for those items. In the depicted examples, the auctioning involves one or more non-price attributes, such as, for example, quality of goods, dates on which goods are accepted, form of payment, and quantity of goods.

Distributed data processing system 100 may include additional servers, clients, and other devices not shown. In the depicted example, distributed data processing system 100 is the Internet with network 102 representing a worldwide collection of networks and gateways that use the TCP/IP suite of protocols to communicate with one another. At the heart of the Internet is a backbone of high-speed data communication lines between major nodes or host computers, consisting of thousands of commercial, government, educational and other computer systems that route data and messages. Of course, distributed data processing system 100 also may be implemented as a number of different types of networks, such as for example, an intranet, a local area network (LAN), or a wide area network (WAN). FIG. 1 is intended as an example, and not as an architectural limitation for the present invention.

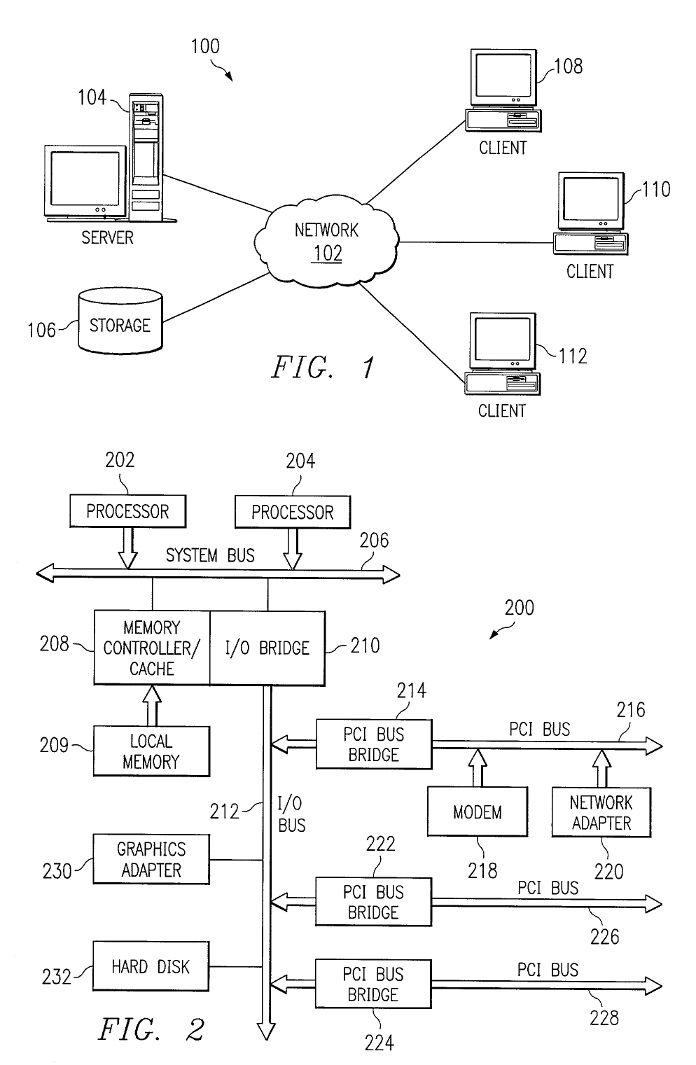

Referring to FIG. 2, a block diagram of a data processing system that may be implemented as a server, such as server 104 in FIG. 1, is depicted in accordance with a preferred embodiment of the present invention. Server 200 may be used to host auction services for non-price auctions in these examples.

Server 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 maybe integrated as depicted.

Peripheral component interconnect (PCI) bus bridge 214 connected to I/O bus 212 provides an interface to PCI local bus 216. A number of modems may be connected to PCI local bus 216. Typical PCI bus implementations will support four PCI expansion slots or add-in connectors. Communications links to clients 108-112 in FIG. 1 may be provided through modem 218 and network adapter 220 connected to PCI local bus 216 through add-in boards.

Additional PCI bus bridges 222 and 224 provide interfaces for additional PCI local buses 226 and 228, from which additional modems or network adapters may be supported. In this manner, server 200 allows connections to multiple network computers. A graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an IBM e-Server pSeries system, a product of International Business Machines Corporation in Armonk, N.Y., running the Advanced Interactive Executive (AIX) operating system or LINUX operating system.

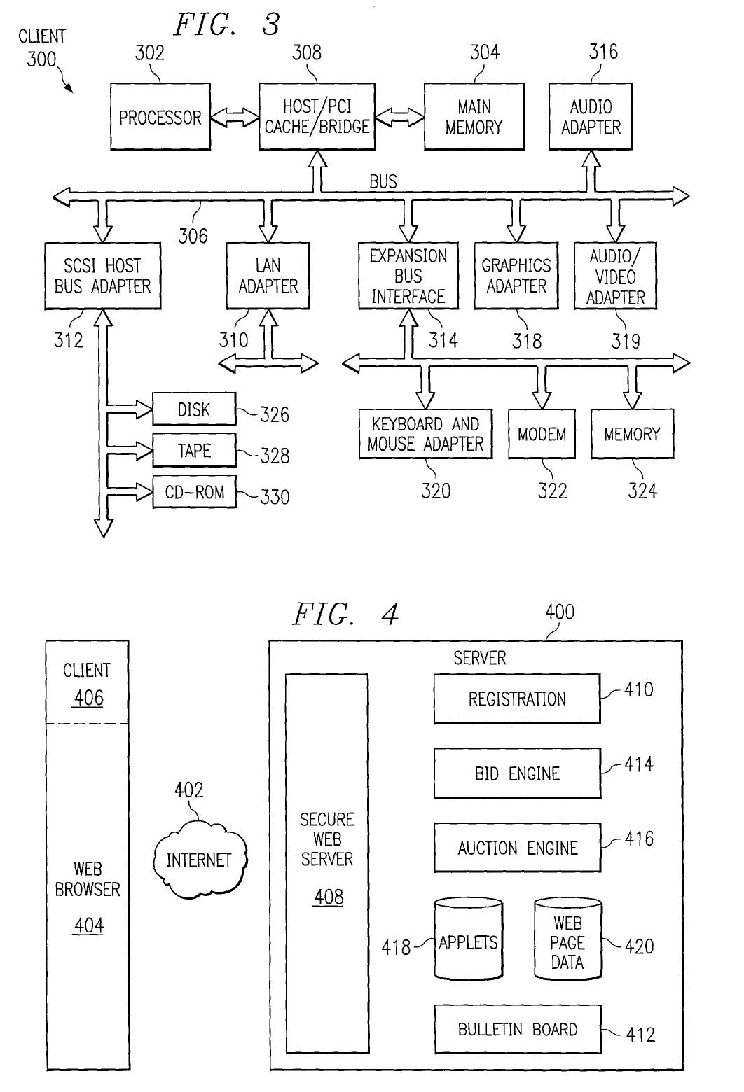

With reference now to FIG. 3, a block diagram illustrating a data processing system in which the present invention may be implemented. Data processing system 300 is an example of a client computer on which bids having non-price attributes may be composed. Data processing system 300 employs a peripheral component interconnect (PCI) local bus architecture. Although the depicted example employs a PCI bus, other bus architectures such as Accelerated Graphics Port (AGP) and Industry Standard Architecture (ISA) may be used. Processor 302 and main memory 304 are connected to PCI local bus 306 through PCI bridge 308. PCI bridge 308 also may include an integrated memory controller and cache memory for processor 302. Additional connections to PCI local bus 306 may be made through direct component interconnection or through add-in boards.

In the depicted example, local area network (LAN) adapter 310, SCSI host bus adapter 312, and expansion bus interface 314 are connected to PCI local bus 306 by direct component connection. In contrast, audio adapter 316, graphics adapter 318, and audio/video adapter 319 are connected to PCI local bus 306 by add-in boards inserted into expansion slots. Expansion bus interface 314 provides a connection for a keyboard and mouse adapter 320, modem 322, and additional memory 324. Small computer system interface (SCSI) host bus adapter 312 provides a connection for hard disk drive 326, tape drive 328, and CD-ROM drive 330. Typical PCI local bus implementations will support three or four PCI expansion slots or add-in connectors.

An operating system runs on processor 302 and is used to coordinate and provide control of various components within data processing system 300 in FIG. 3. The operating system may be a commercially available operating system, such as Windows 2000, which is available from Microsoft Corporation. An object oriented programming system such as Java may run in conjunction with the operating system and provides calls to the operating system from Java programs or applications executing on data processing system 300. “Java” is a trademark of Sun Microsystems, Inc. Instructions for the operating system, the object-oriented operating system, and applications or programs are located on storage devices, such as hard disk drive 326, and may be loaded into main memory 304 for execution by processor 302.

Those of ordinary skill in the art will appreciate that the hardware in FIG. 3 may vary depending on the implementation. Other internal hardware or peripheral devices, such as flash ROM (or equivalent nonvolatile memory) or optical disk drives and the like, may be used in addition to or in place of the hardware depicted in FIG. 3. Also, the processes of the present invention may be applied to a multiprocessor data processing system.

Data processing system 300 may take various forms, such as a stand-alone computer or a networked computer. As a further example, data processing system 300 may be a personal digital assistant (PDA) device, which is configured with ROM and/or flash ROM in order to provide nonvolatile memory for storing operating system files and/or user-generated data. The depicted example in FIG. 3 and above-described examples are not meant to imply architectural limitations. For example, data processing system 300 also may be a notebook computer or hand held computer in addition to taking the form of a PDA. Data processing system 300 also may be a kiosk or a Web appliance. The present invention provides a method, apparatus, and computer implemented instructions to allow auctions based on non-price attributes. With this mechanism, the price for items, such as goods or services, is fixed when auctioning occurs. With this mechanism, bidders may bid on other attributes, such as quantity, date of delivery, latest date of delivery, earliest date of delivery, quality of goods, distribution capabilities, demographics or geographic location of the final customer, willingness to include marketing support, transaction terms and conditions, such as shipping, payment means, payment terms, and carrier used for shipping. One or more non-price attributes may be used in auctioning items. For example, bidders may bid on quantity with the bidder offering the largest quantity winning the auction. The items may be goods or services and may even include, for example, derivatives, such as futures contracts, forward contracts, options, options on futures contracts, and options on forward contracts.

Turning next to FIG. 4, a diagram illustrating components used in an Internet auction is depicted in accordance with a preferred embodiment of the present invention. In this example, server 400 hosts auction services, which may be accessed across Internet 402. For example, a buyer or user uses Web browser 404 in client 406. Through Web browser 404, the buyer may receive information on items being auctioned on server 400 as well as submit bids for those items. The bids are non-price bids according to the present invention. The price for these items are fixed.

In this example, server 400 includes a secure Web server 408, which is used to receive and process requests for information and bids. In this example, secure Web server 408 uses various known encryption techniques to provide privacy and security for buyers submitting bids. Secure Web server 408 sends received requests to appropriate components, such as registration 410, bulletin board 412, bid engine 414, and auction engine 416 for processing.

Additionally, secure Web server 408 will receive results and format those results for return to the originator of the requests. In these examples, the requests are received in an HTTP format and placed in the appropriate form for use by other components in server 400. Further, secure Web server 408 will reformat the responses from these components into the appropriate form for return to the requester.

Registration 410 is used to identify and register users who participate in the auctions. Bulletin board 412 in these examples are used to provide information, such as identification of items being auctioned as well as quantities of these items and descriptions of the items. Bid engine 414 provides a bid handling process to analyze and receive bids, identify winners of auctions, and set prices for the items. Bid engine 414 may handle a single auction or many auctions. Bid engine 414 may identify winners using a policy in which the policy includes at least one of a set of rules, a model, heuristics, optimization, and objective functions. Bid engine 414 may include various auction mechanisms, such as sealed bids. These auctions may be performed using various auctions parameters, such as reserve attribute, “take-it”, and a minimum bidding increment. Further, the auction mechanism may include, for example, ascending auctions, descending auctions, clock auctions, buy-side auctions, sell-side auctions, and two-sided auctions. If, for example, the auction is based on quantity, a bidder may try to achieve the highest or lowest quantity, depending on whether the auction is a buy-side auction or a sell-side auction. Similarly, the bidder may try to be closest to a specified quantity, or alternatively may try to be closest to a specified quantity while simultaneously being either greater than or less than a specified quantity. Additionally, the winning bid may be selected based on one of a highest bid, lowest bid, bid closest to a specific value for the parameter, bid less than and closest to a specific value for the parameter, bid greater than and closest to a specific value for the parameter, and a first bid within a designated range.

Although in this example, the auction was based on quantity, in practice the auction could be based on other attributes, such as quality and lead time. In all cases, selection of the winning bid will depend on the identified attributes and whether the auction is a buy-side auction, a sell-side auction, or a two-sided auction.

In the depicted examples, auction engine 416 contains the processes used to provide utility functions, programs, or Web pages to bidders for single or multi-attribute non-price auctions. In other words, auction engine 416 is used to provide offering of items to be auctioned to users as well as a mechanism or medium for entering bids on the items. As used herein, a multi-attribute auction is an auction in which multiple parameters may be set in generating a bid. For example, these attributes may include the quality of the item, the terms of delivery, and terms of payment.

Auction engine 416 in these examples may send a utility function, such as an applet from applets 418 to a bidder or user, such as a user at Web browser 404 at client 406. This applet provides a graphical user interface (GUI) used to display information to a user as well as allow a user to compose bids in the multi-attribute auction. Alternatively, instead of sending a program, such as an applet to the bidder, the GUI may be supplied through Web pages using Web page data 420. These Web pages may take various forms, such as a static Web HTML page stored in Web page data 420 or a dynamically generated Web page using data in Web page data 420.

The components shown in FIG. 4 are for illustrative purposes and not meant as limitations to the implementation of the present invention. Other components may be used in addition to or in place of the illustrated components for providing auction services using bids with one or more non-price attributes.

With reference now to FIG. 5, a flowchart of a process used for offering one or more items for auction is depicted in accordance with a preferred embodiment of the present invention. The process illustrated in FIG. 5 may be implemented in an auction engine, such as auction engine 416 in FIG. 4.

The process begins by receiving a request to bid on items (step 500). Next, bid attributes are identified for a parameter (step 502). A bid page is generated (step 504). In this example, the bid page is a Web page identifying one or more attributes, which are to be used in submitting bids. This bid page also includes an identification of the price for items. Further, the bid page also may include a mechanism for returning bids on the attribute or attributes on which bidding is to occur. Then, the bid page is returned to the requestor (step 506) with the process terminating thereafter.

Alternatively, a program or function embodied in an Applet may be sent to the requestor for bidding on items. The particular form on which the attribute or attributes are returned to the requestor are not meant as limitation in the implementation of the present invention.

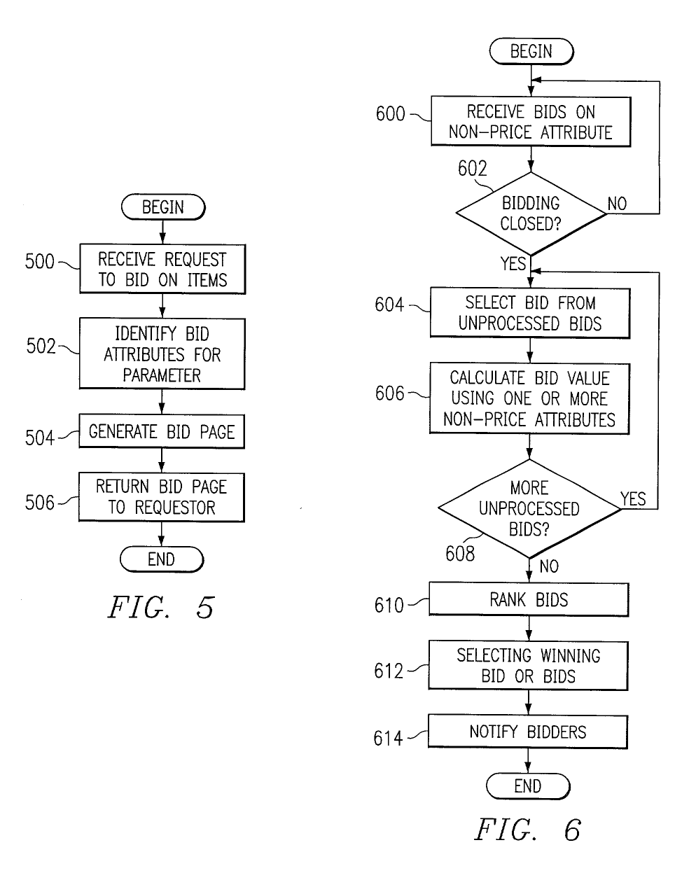

Turning next to FIG. 6, a flowchart of a process used for selecting a winner of an auction is depicted in accordance with a preferred embodiment of the present invention. The process illustrated in FIG. 6 may be implemented in a bid engine, such as bid engine 414 in FIG. 4.

The process begins by receiving bids on a non-price attribute (step 600). In the depicted examples, the bids may be received as information returned from a Web page or an Applet. A determination is then made as to whether the bidding is closed (step 602). If the bidding is closed, no more bids are to be accepted. On the other hand, if the bidding is not closed, the process returns to step 600 to accept additional bids. When the bidding is closed, a bid is selected from unprocessed bids (step 604). A bid value is calculated using one or more non-price attributes (step 606). Next, a determination is made as to whether additional unprocessed bids are present (step 608). If more unprocessed bids are present the process returns to step 604.

If no more unprocessed bids are present, the bids are ranked (step 610), and a winning bid or bids are selected (step 612). Ranking may be achieved using various mechanisms depending on the number of attributes and the value to each attribute. For example, with multiple attributes, all of the attributes may be weighted equally or some attributes may be weighted heavier than others. Various processes known to those of ordinary skill in the art may be used to implement the weighting of attributes to generate a value for each bid with the bids being ranked based on the values. Then, the winning bidder or bidders are notified (step 614) with the process terminating thereafter.

Thus, the present invention provides an improved method, apparatus, and computer implemented instructions for non-price auctions. Through auctioning items using one or more non-price attributes, the mechanism of the present invention provides additional flexibility to parties in auctions in which a fixed price is desired. These auctions may include, for example, combinations of goods or services at a fixed price with bidding occurring through a single attribute. The auction may include offering a single good or service at a fixed price with bidding through multiple non-price attributes. Combinations of goods or services at a fixed price may be offered with bidding occurring through multiple non-price attributes. These non-price attributes or parameters may be, for example, a quantity, quality, lead time, delivery date, physical distribution characteristics, demographics of customer, geographic location of customer, the ability to provide collateral marketing support, or transaction terms and conditions. Those of ordinary skill in the art are aware that many other types of non-price auctions may be implemented using the mechanism of the present invention.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method in a data processing system for auctioning, the method comprising:
providing a parameter for bidding on items, wherein the parameter excludes price;
receiving a set of bids for the items based on the parameter; and
identifying a winning bid from the set of bids.

2. The method of claim 1, wherein the identifying step is performed using a policy.

3. The method of claim 2, wherein the policy comprises at least one of a set of rules, a model, heuristics, and objective functions.

4. The method of claim 1, wherein the items are derivatives.

5. The method of claim 4, wherein the derivatives are at least one of futures contracts, forward contracts, options, options on futures contracts, and options on forward contracts.

6. The method of claim 1, wherein the parameter is one of a quantity, a quality, a lead time, a delivery date, physical distribution characteristics, demographics of customer, a geographic location of customer, an ability to provide collateral marketing support, or transaction terms and conditions.

7. The method of claim 1, wherein additional non-price parameters are provided for bidding.

8. The method of claim 1, wherein the winning bid is selected based on one of a highest bid, a lowest bid, a bid closest to a specific value for the parameter, and a first bid within a designated range.

9. The method of claim 1, wherein the items are within a single class.

10. The method of claim 1, wherein the items are in multiple classes.

11. A data processing system for processing bids, the data processing system comprising:
an auction engine; and
a policy specifying a non-price parameter for bidding on items.

12. The data processing system of claim 11, wherein the auction engine processes at least one of ascending auctions, descending auctions, clock auctions, first price auctions, second price auctions, buy-side auctions, sell-side auctions, and two sided auctions.

13. The data processing system of claim 11, wherein the auction engine processes sealed bids.

14. The data processing system of claim 11, wherein the policy is implemented using at least one of a set of rules, a model, heuristics, and objective functions.

15. The data processing system of claim 11, wherein the items are derivatives.

16. The data processing system of claim 15, wherein the derivatives are at least one of futures contracts, forward contracts, options, options on futures contracts, and options on forward contracts.

17. A data processing system comprising:
a bus system;
a communications unit connected to the bus system;
a memory connected to the bus system, wherein the memory includes as set of instructions; and
a processing unit connected to the bus system, wherein the processing unit executes the set of instructions to provide a parameter for bidding on items, wherein the parameter excludes price; receive a set of bids for the items based on the parameter; and identify a winning bid from the set of bids.

18. The data processing system of claim 17, wherein the data communications unit provides a connection to at least one of a wide area network, a local area network, a wireless network, a data communication network, an Internet, an intranet, and an extranet.

19. A data processing system for auctioning, the data processing system comprising:
providing means for providing a parameter for bidding on items, wherein the parameter excludes price;
receiving means for receiving a set of bids for the items based on the parameter; and
identifying means for identifying a winning bid from the set of bids.

20. The data processing system of claim 19, wherein the identifying means is performed using a policy.

21. The data processing system claim 20, wherein the policy comprises at least one of a set of rules, a model, heuristics, optimization, and objective functions.

22. The data processing system of claim 19, wherein the items are derivatives.

23. The data processing system of claim 22, wherein the derivatives are at least one of futures contracts, forward contracts, options, options on futures contracts, and options on forward contracts.

24. The data processing system of claim 19, wherein the parameter is one of a quantity, a quality, a lead time, a delivery date, physical distribution characteristics, demographics of customer, a geographic location of customer, an ability to provide collateral marketing support, or transaction terms and conditions.

25. The data processing system of claim 19, wherein additional non-price parameters are provided for bidding.

26. The data processing system of claim 19, wherein the winning bid is selected based on one of a highest bid, lowest bid, a bid closest to a specific value for the parameter, a bid less than and closest to a specific value for the parameter, a bid greater than and closest to a specific value for the parameter, and a first bid within a designated range.

27. The data processing system of claim 19, wherein the items are within a single class.

28. The data processing system of claim 19, wherein the items are in multiple classes.

29. A computer program product in a computer readable medium for auctioning, the computer program product comprising:
first instructions for providing a parameter for bidding on items, wherein the parameter excludes price;
second instructions for receiving a set of bids for the items based on the parameter; and
third instructions for identifying a winning bid from the set of bids.

30. The computer program product of claim 29, wherein the third instructions are performed using a policy.

31. The computer program product of claim 30, wherein the policy comprises at least one of a set of rules, a model, heuristics, optimization, and objective functions.

32. The computer program product of claim 29, wherein the items are derivatives.

33. The computer program product of claim 32, wherein the derivatives are at least one of futures contracts, forward contracts, options, options on futures contracts, and options on forward contracts.

34. The computer program product of claim 29, wherein the parameter is one of a quantity, a quality, a lead time, a delivery date, physical distribution characteristics, demographics of customer, a geographic location of customer, an ability to provide collateral marketing support, or transaction terms and conditions.

35. The computer program product of claim 29, wherein additional non-price parameters are provided for bidding.

36. The computer program product of claim 29, wherein the winning bid is selected based on one of a highest bid, a lowest bid, a bid closest to a specific value for the parameter, a bid less than and closest to a specific value for the parameter, a bid greater than and closest to a specific value for the parameter, and a first bid within a designated range.

37. The computer program product of claim 29, wherein the items are within a single class.

38. The computer program product of claim 29, wherein the items are in multiple classes.
